(19) United States
(12) Patent Application Publication
(10) Pub. No.: US 2026/0188788 A1
(43) Pub. Date: Jul. 2, 2026

(54) COMPRESSED BATTERY THERMAL BARRIER AND METHOD

(71) Applicant: Aspen Aerogels, Inc., Northborough, MA (US)

(72) Inventors: John Williams, Northborough, MA (US); Lixin Wang, Northborough, MA (US)

(21) Appl. No.: 19/129,513

(22) PCT Filed: Sep. 15, 2023
(86) PCT No.: PCT/US2023/032917

§ 371 Date: May 13, 2025

Related U.S. Application Data
(60) Provisional application No. 63/426,304, filed on Nov. 17, 2022.

(51) Int. Cl. H01M 10/658; B32B 7/12; B32B 9/04; B60L 50/64; H01M 10/04; H01M 10/0525; H01M 10/625; H01M 10/647; H01M 50/211; H01M 50/293

(52) U.S. Cl. CPC H01M 10/658; B32B 7/12; B32B 9/04; H01M 10/0481; H01M 10/0525; H01M 10/625; H01M 10/647; H01M 50/211; H01M 50/293; B32B 2250/05; B32B 2307/302; B32B 2307/304; B32B 2307/51; B32B 2457/10; B60L 50/64; H01M 2220/20

(57) ABSTRACT

A multilayer thermal barrier, batten7 modules, and associated methods are disclosed. In one example, a resilient layer of a multilayer thermal barrier is dimensioned to a footprint substantially the same size as a lithium-ion pouch cell. Configurations are shown where a thermal insulation layer extends laterally beyond the footprint.

### CLAIM OF PRIORITY

This application claims the benefit of priority to U.S. Patent Application Ser. No. 63/426,304, filed on Nov. 17, 2022, which is incorporated by reference herein in its entirety.

### TECHNICAL FIELD

The present disclosure relates generally to materials and systems and methods for preventing or mitigating thermal events, such as thermal runaway issues, in energy storage systems. In particular, the present disclosure provides thermal barrier materials. The present disclosure further relates to a battery module or pack with one or more battery cells that includes the thermal barrier materials, as well as systems including those battery modules or packs. Examples described generally may include aerogel materials.

### BACKGROUND

Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged (being charged beyond the designed voltage), over-discharged, operated at or exposed to high temperature and high pressure.

To prevent cascading thermal runaway events from occurring, there is a need for effective insulation and heat dissipation strategies to address these and other technical challenges of LIBs.

### BRIEF DESCRIPTION OF THE DRAWINGS

FIG. 1A shows a side view of selected portions of a battery module in accordance with some example aspects.

FIG. 1B shows a top view of selected portions of a battery module in accordance with some example aspects.

FIG. 2A shows a side view of selected portions of a multilayer thermal barrier in accordance with some example aspects.

FIG. 2B shows a side view of selected portions of a multilayer thermal barrier in accordance with some example aspects.

FIG. 2C shows a side view of selected portions of a multilayer thermal barrier in accordance with some example aspects.

FIG. 2D shows a side view of selected portions of a multilayer thermal barrier in accordance with some example aspects.

FIG. 2E shows a side view of selected portions of a battery module in accordance with some example aspects.

FIG. 2F shows a side view of selected portions of a battery module in accordance with some example aspects.

FIG. 3A shows a side view of selected portions of a multilayer thermal barrier in accordance with some example aspects.

FIG. 3B shows a side view of selected portions of a multilayer thermal barrier in compression in accordance with some example aspects.

FIG. 3C shows a side view of selected portions of a multilayer thermal barrier in compression in accordance with some example aspects.

FIG. 4 shows a flow diagram of a method in accordance with some example aspects.

FIG. 5 shows an electronic device in accordance with some example aspects.

FIG. 6 shows an electric vehicle in accordance with some example aspects.

### DESCRIPTION OF ASPECTS

The following description and the drawings sufficiently illustrate specific aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

### General Overview

The present disclosure is direct to battery module with multilayer thermal barriers. The multilayer thermal barriers comprise at least a thermal insulation layer to prevent fire/heat propagation in extreme situations such as thermal runaway. The multilayer thermal barriers may optionally comprise a resilient layer and a heat conductive layer. The resilient layer is to accommodate the volume changes of the battery cells. The conductive layer is to better regulate the heat flow generated by the battery cells and to protect the thermal insulation layer from particle bombardments during thermal runaway. The design of the multilayer thermal barriers prevents any damage to the battery cells during compression in initial assembling and subsequent operation of the battery module.

Insulating layers between battery cells, such as lithium ion battery (LIB) cells may act as a safety component that prevents or reduces the transfer of excess heat between cells. Preventing/reducing heat transfer between cells may perform the important safety function of reducing the likelihood of a “thermal runaway” event from starting and/or from delaying the start of such an event.

However, the requirements for an effect thermal barrier layer between cells extend beyond simply thermal insulating properties. The environment within a battery pack may be demanding beyond the thermal regime, and may in some aspects include certain mechanical properties. In one illustrative aspect, a thermal barrier may also preferably exhibit a degree of durability so that it may be formed into, and act as, a barrier or channel that prevents the ejecta from a thermal runaway event from degrading other components of the battery pack (including other LIB cells). In other aspects, an effective thermal barrier may also exhibit certain mechanical properties that reflect the dynamic conditions within a battery pack. This aspect may include mechanical resilience and compressibility that accommodates the expansion and contraction of battery cells during charging and discharging. Mechanical resilience and compressibility may enable a thermal barrier to maintain contact with adjacent cells consistently through the dimensional changes normally exhibited by cells during their operational and charging cycles. Accomplishing these demanding performance goals is challenging for the many different types of insulation materials that can be used as thermal barriers.

In aspects described below, various multilayer thermal barriers are described that include an insulating layer that is stacked with one or more different layers. In various aspects, the different layers may exhibit different properties so that the multilayer thermal barrier, as a composite element, may meet multiple design criteria more effectively than a single layer (e.g., a single layer of insulating material). In some aspects, an insulating layer may be stacked with (and/or attached to) a resilient layer so that the multilayer stack may accomplish both mechanical requirements and thermal requirements necessary for a thermal barrier to be effective. In some aspects, one or more of the layers of a multilayer thermal barrier may have extensions areas so that the outline or profile (“footprint”) of the one or more layers of the multilayer thermal barrier extend beyond the footprint of a corresponding LIB cell.

### Materials for Insulation Layer

Insulation materials, as described in examples below, can be used as a single heat resistant layer, or in combination with other layers that provide additional function to a multilayer configuration, such as mechanical strength, compressibility, heat dissipation/conduction, etc. Insulation layers of a multilayer materials described herein are responsible for reliably containing and controlling heat flow from heat-generating parts in small spaces and to provide safety and prevention of fire propagation for such products in the fields of electronic, industrial and automotive technologies.

In many aspects of the present disclosure, the insulation layer functions as a flame/fire deflector layer either by itself or in combination with other materials that enhance performance of containing and controlling heat flow. For example, the insulation layer may itself be resistant to flame and/or hot gases and further include entrained particulate materials that modify or enhance heat containment and control.

One example of a highly effective insulation layer includes an aerogel. Aerogels describe a class of material based upon their structure, namely low density, open cell structures, large surface areas (often 900 m2/g or higher) and subnanometer scale pore sizes. The pores may be filled with gases such as air. Aerogels can be distinguished from other porous materials by their physical and structural properties. Although an aerogel material is an exemplary insulation material, the invention is not so limited. Other thermal insulation material layers such as mica, microporous silica, ceramic fiber, mineral wool, and combinations thereof, both with and without aerogel materials, may also be used in examples of the present disclosure.

Selected examples of aerogel formation and properties are described. In several examples, a precursor material is gelled to form a network of pores that are filled with solvent. The solvent is then extracted, leaving behind a porous matrix. A variety of different aerogel compositions are known, and they may be inorganic, organic and inorganic/organic hybrid. Inorganic aerogels are generally based upon metal alkoxides and include materials such as silica, zirconia, alumina, and other oxides. Organic aerogels include, but are not limited to, urethane aerogels, resorcinol formaldehyde aerogels, and polyimide aerogels.

Inorganic aerogels may be formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxylsilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain aspects of the present disclosure, pre-hydrolyzed TEOS, such as Silbond H-5 (SBH5, Silbond Corp), which is hydrolyzed with a water/silica ratio of about 1.9-2, may be used as commercially available or may be further hydrolyzed prior to incorporation into the gelling process. Partially hydrolyzed TEOS or TMOS, such as polyethy silicate (Silbond 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one example, organic RF aerogels are typically made from the sol-gel polymerization of resorcinol or melamine with formaldehyde under alkaline conditions.

Organic/inorganic hybrid aerogels are mainly comprised of (organically modified silica (“ormosil”) aerogels. These ormosil materials include organic components that are covalently bonded to a silica network.

Ormosils are typically formed through the hydrolysis and condensation of organically modified silanes, R—Si(OX)₃, with traditional alkoxide precursors, Y(OX)₄. In these formulas, X may represent, for example, CH₃, C₂H₅, C₃H₇, C₄H₉; Y may represent, for example, Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

Aerogels can be formed from flexible gel precursors. Various flexible layers, including flexible fiber-reinforced aerogels, can be readily combined and shaped to give pre-forms that when mechanically compressed along one or more axes, give compressively strong bodies along any of those axes.

One method of aerogel formation includes batch casting. Batch casting includes catalyzing one entire volume of sol to induce gelation simultaneously throughout that volume. Gel-forming techniques include adjusting the pH and/or temperature of a dilute metal oxide sol to a point where gelation occurs. Suitable materials for forming inorganic aerogels include oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability and low cost (alcogel). Organic aerogels can also be made from melamine formaldehydes, resorcinol formaldehydes, and the like.

As noted above, an aerogel may be organic, inorganic, or a mixture thereof. In some examples, the aerogel includes a silica-based aerogel. One or more layers in a thermal barrier may include a reinforcement material. The reinforcing material may be any material that provides resilience, conformability, or structural stability to the aerogel material. Examples of reinforcing materials include, but are not limited to, open-cell macroporous framework reinforcement materials, closed-cell macroporous framework reinforcement materials, open-cell membranes, honeycomb reinforcement materials, polymeric reinforcement materials, and fiber reinforcement materials such as discrete fibers, woven materials, non-woven materials, needled non-wovens, battings, webs, mats, and felts.

The reinforcement material can be selected from organic polymer-based fibers, inorganic fibers, carbon-based fibers or a combination thereof. The inorganic fibers are selected from glass fibers, rock fibers, metal fibers, boron fibers, ceramic fibers, basalt fibers, or combination thereof. In some examples, the reinforcement material can include a reinforcement including a plurality of layers of material.

In addition to thermal insulating layers, thermally conductive layers in combination with thermal insulating layers are effective at channeling unwanted heat to a desired external location, such as external heat dissipating fins, a heat dissipating housing, or other external structure to dissipate unwanted heat to outside ambient air. In one example, a thermally conductive layer or layers helps to dissipate heat away from a localized heat load within a battery module or pack. Examples of high thermal conductivity materials include carbon fiber, graphite, silicon carbide, metals including but not limited to copper, stainless steel, aluminum, and the like, as well as combinations thereof.

### Insulation Layer Assemblies

In some aspects, any of the multilayer thermal barriers described herein may be coupled to a heat sink as a way of further facilitating the distribution and removal of heat. It will be appreciated that there are a variety of heat sink types and configurations, as well as different techniques for coupling the heat sink to the thermally conductive layer, and that the present disclosure is not limited to the use of any one type of heat sink/coupling technique. For example, at least one thermally conductive layer of the multilayer materials disclosed herein can be in thermal communication with an element of a cooling system of a battery module or pack, such as a cooling plate or cooling channel of the cooling system (i.e., “active cooling”). For another example, at least one thermally conductive layer of the multilayer materials disclosed herein can be in thermal communication with other elements of the battery pack, battery module, or battery system that can function as a heat sink, such as the walls of the pack, module or system, or with other ones of the multilayer materials disposed between battery cells. Thermal communication between the thermally conductive layer of the multilayer materials and heat sink elements within the battery system can allow for removal of excess heat from the cell or cells adjacent to the multilayer material to the heat sink, thereby reducing the effect, severity, or propagation of a thermal event that may generate excess heat.

As described herein, a multilayer thermal barrier includes one or more insulating layers (the materials and methods of which are described above, such as aerogels) and at least one other layer. In some aspects, in addition to the one or more thermal insulating layers, the multilayer thermal barrier assembly may include one or more of: (a) one or more thermally conductive layers and/or (b) one or more resilient material layers. In one illustration, a resilient layer, when included in a multilayer thermal barrier, may compress to accommodate expansion of one or more battery cells adjacent to the multilayer thermal barrier. In one scenario, battery cells may expand during a charge cycle, and contract during a discharge cycle. A multilayer thermal barrier that includes a resilient layer may compress in response to the applied pressure of adjacent expanding cells and may expand in response to the reduction in pressure as the cells contract. In one illustration, the resilient layer may also absorb permanent volume expansion caused by any battery cell degradation and/or thermal runaway, and not just respond to cyclical, reversable expansion and contraction. Resilient material layers may include, but are not limited to, foam, fiber, fabric, sponge, spring structures, rubber, polymer, and combinations thereof.

As also described herein, a multilayer thermal barrier may also include one or more thermally conductive layers to facilitate the transmission of heat. The thermal conductive layers may also protect the insulating layer and the resilient layer disposed between the thermal conductive layers from the particle bombardments in the case of thermal runaway. In some aspects, the thermal conductive layers each has a footprint (defined by width times length) equals to the footprint of the resilient layer and/or equals to the footprint of the battery cells 112 (defined by the width and length of the electrodes). In some aspects, any of the multilayer thermal barriers described herein may be adapted to any configuration of battery cells, including but not limited to prismatic or pouch cells.

### Pouch Cell with Thermal Barrier

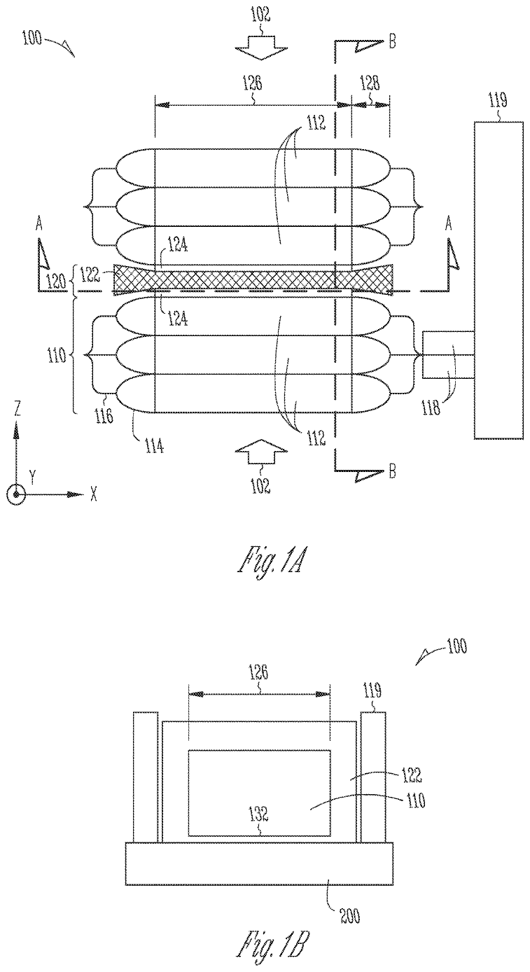

FIG. 1A shows one example of a battery module 100 that includes a multilayer thermal barrier of the present disclosure. The battery module 100 includes a plurality of cells 112, all of which are contained in pouches 114. The battery module 100 also includes electrical contacts 116, a bus 118, an electric circuit 119, and a thermal barrier 120.

The cells 112 of the battery module 100 may include lithium-ion cells, although the invention is not so limited. Other electrochemical cells and battery configurations that benefit from a thermal barrier are also within the scope of the invention.

In the aspect shown, groups of cells 112 are associated together into corresponding pouches 114. Multiple pouches 114 are electrically connected together in a group 110 of pouches 114.

In a pouch 114, the electrodes (not shown), separators (not shown), and electrolyte (not shown) of the battery cells 112 are disposed in a center portion of the pouch 114 defined by a footprint 126, while the end portions of the pouch 114 are filled extra electrolyte. The major surfaces (width times length) of the battery cells 112 are defined as the footprint of the battery cells 112. In other battery cell shapes, the footprint may include other areal shapes, such as an oval, diamond, or other shape. Terminals 116 are configured to contact the cell(s) 112 and extend from the pouch 114, as shown. Pouch cells or prismatic cells are frequently used in electric vehicle battery modules and can be used with the aspects and examples discussed herein.

In addition to encasing the cells 112, each of the pouches 114 also includes electrical contacts 116 that connect to the cells 112. In the example of FIG. 1A, multiple terminals 116 from individual cells 112 of the group 110 are coupled together, either physically or electrically.

The terminals 116 may be connected with a bus 118 or other analogous electrical structure. In one example, the bus 118 includes a slot that narrows from one side to another. As the terminals 116 slide into the bus 118, they are compressed, and a robust electrical connection is made that does not require fasteners or tools to assemble. The bus 118 may be connected to an electric circuit 119.

The battery module 100 further includes a thermal barrier 120 located between cell groups 110. In some aspects, the thermal barrier 120 may include a single layer. For example, the thermal barrier 120 may include a thermal insulation layer 122, fabricated from an insulating material (e.g., aerogel, ceramic fibers). In some examples, the single barrier layer may be coated with a protective barrier, such as a polymer encapsulant, or an inorganic or organic material coating. In some examples, the protective barrier may be applied using a dip coating process, doctor blade, evaporative coating, spin coating, spraying, chemical vapor deposition, or the like. In other examples, a polymer encapsulant may be physically applied in the form of a polymer film.

In other aspects, the thermal barrier 120 may be a multilayer thermal barrier 120 that includes a thermal insulation layer 122 and at least one resilient layer 124. In the example of FIG. 1A, two resilient layers 124 are shown, located on opposing major surfaces of the thermal insulation layer 122 so that the thermal insulation layer 122 is between opposing major surfaces of the two resilient layers 124, although the invention is not so limited.

As explained in more detail below, the dimensions of the major surfaces (i.e., width and length) of the resilient layer(s) 124 may be approximately the same (e.g., 5% or less) than the dimensions of the major surfaces (i.e., width and length) of the thermal insulation layer 122. In other aspects, the height and length dimensions of the major surfaces of the resilient layer(s) 124 and the insulation layer 122 may be different. For convenience, the width and length of a major surface is referred to as a “footprint.” In some aspects, the footprint of the resilient layers is the same as the footprint (defined by the width times length of the electrodes) of the battery cells 112.

As shown in the example battery module 100, the thermal insulation layer 122 extends laterally beyond the footprint 126 of the resilient layer 124 by a distance indicated by dimension 128. The dimension 128 may be configured and dimensioned to fit within a battery compartment, a frame of a battery pack, or other similar externally imposed design constraint. The battery cells 112 in the battery module 100 are compressed against each other during assembly to maintain a pressure within each battery cell 112. The pressure on each of the battery cells 112 keeps electrical contact between the active components of the battery cells 112 disposed within the pouch 114. For example, a stack of cells 112 are compressed as shown by arrows 102 in FIG. 1A.

In a compression operation, the multilayer thermal barrier 120 is also compressed. In configurations where multiple layers of the multilayer thermal barrier 120 extend laterally beyond the footprint 126, the laterally extending portion may not compress, and instead curl upwards and downwards or swell at the ends. This can cause unwanted interference with the pouch 114 and the terminals 116. If excessing curling or swelling occurs, the terminals 116 may be damaged.

In the configuration shown in Figure IA, only the thermal insulation layer 122 extends laterally beyond the footprint 126. This provides a thermal barrier that is wider than the footprint 126, which provides increased thermal protection between cells 112 or sub-units 110. However, the unwanted curling of other layers in the multilayer thermal barrier 120 is avoided by configuring other layers such as the resilient layer 124 dimensioned with a footprint substantially the same size as the footprint 126. In one example, the thermal insulation layer 122 extends beyond footprint 126 to block heat and venting material from traveling between battery sub-units 110.

In one aspect, one or more thermal conductor layers are also included as part of the multilayer thermal barrier 120. The one or more thermal conductor layers help to remove excess heat from a cell or cells 112 adjacent to the multilayer material to a heat sink. FIG. 1B shows a cross section view of the battery module 100 along line A-A, including a heat sink 130. The sub-unit 110 is shown with the thermal insulation layer 122 extending laterally beyond the footprint 126. Inclusion of one or more thermal conductor layers with the multilayer thermal barrier 120 facilitates heat conduction laterally within the one or more thermal conductor layers, and out to the heat sink 130 by thermal contact at interface 132. In one example, an additional thermal conductor, such as a metal layer, is coupled between the thermal conductor layers in the multilayer thermal barrier 120 and the heat sink 130, providing a continuous lateral thermal pathway from a center of the cells 112 out to the heat sink 130.

In some aspects, the lateral extension of the thermal insulation layer 122 provides increased thermal protection between cells 112 or groups 110 of cells 112. In one example, the thermal insulation layer (122) extends beyond footprint 126 to block heat and ejecta produced by a thermal runaway event from traveling between battery sub-units 110.

### Thermal Barrier Configurations

Thermal barriers, particularly multilayer thermal barriers, are composite structures that, by virtue of the different properties of their diverse layers, can be designed to have multiple properties not easily achieved via a single layer alone. For example, while thermal barriers will commonly include a thermal insulation layer, as described above, various other configurations may include one or more different layers to accomplish goals not strictly related to thermal insulation. In various aspects, the one or more different layers may include, but are not limited to, resilient layers, thermal conduction layers, dust barriers, and the like. The dimensions of the diverse layers are designed to serve their respective purposes. For example, the insulation layer may extend beyond the footprint of the battery cells to better block the heat during thermal runaway. The insulation layer may have thin edges to prevent accidental damage to the pouch or terminal of the battery cells. The resilient layer and the conductive layer are usually the same as the battery cell footprints to provide suitable pressure among battery cells and to dissipate heat generated by the battery cells.

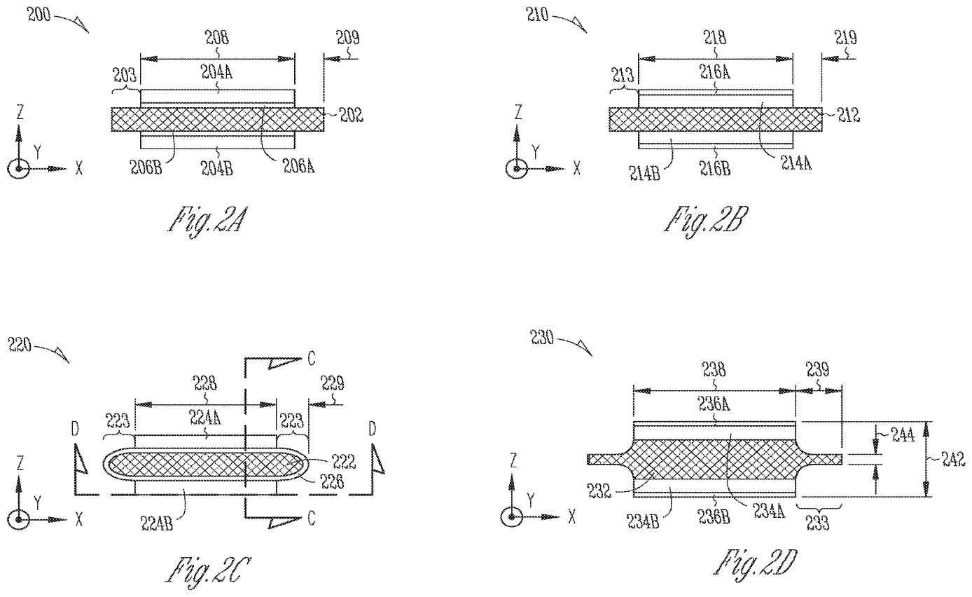

FIGS. 2A-2D show selected configurations of multilayer thermal barriers. The compositions of the various layers have been described above. Those descriptions are equally applicable to analogous layers in the configurations described below.

Turning first to FIG. 2A, a multilayer thermal barrier 200 includes a thermal insulation layer 202, a first resilient layer 204A, a second resilient layer 204B (collectively, resilient layers 204), a first thermal conductive layer 206A and a second thermal conductive layer 206B (collectively, thermal conductive layers 206).

As shown, the thermal insulation layer 202, fabricated from any of the materials described above, may have one or more dimensions that extend beyond the corresponding dimension of one or more of the other layers. In the case of the multilayer thermal barrier 200, the thermal insulation layer 202 extends in the illustrated dimension beyond all of the resilient layers 204 and thermal conductor layers 206 by a dimension 209. In other aspects, not shown, one or more of the resilient layers 204 and/or thermal conductive layers 206 may have one or more dimensions that are comparable to corresponding dimensions of the thermal insulation layer 202.

In some aspects of the multilayer thermal barrier 200, the thermal conductive layers 206A and 206B are adjacent to opposing major surfaces of the thermal insulation layer 202. In some aspects, the thermal conductive layers 206A and 206B are in direct contact with the corresponding major surfaces of the thermal insulation layer 202. In other aspects, the thermal conductive layers 206A and 206B are in indirect contact with the corresponding major surfaces of the thermal insulation layer 202. In the aspect of indirect contact, an adhesive, or thermally conductive adhesive/interface material (e.g., graphite paste, an adhesive filled with conductive particles) may be disposed between the thermal conductive layers 206A and 206B and the thermal insulation layer 202.

The resilient layers 204 in the multilayer thermal barrier 200 are in contact with the thermal conductive layers 206 so that both of the thermal insulation layer 202 and the thermal conductive layers 206 are between the resilient layers 204A and 204B. In some aspects, the resilient layers 204 are in direct contact with their corresponding thermal conductive layers 206. In other aspects, an adhesive or other layer may be present between one of the resilient layers 204 and the corresponding thermal conductive layer 206.

FIG. 2B a multilayer thermal barrier 210 that has an alternative configuration to the multilayer thermal barrier 200 in FIG. 2A. The multilayer thermal barrier 210 includes a thermal insulation layer 212, a first resilient layer 214A, a second resilient layer 214B, a first thermal conductive layer 216A, and a second thermal conductive layer 216B.

The materials for the various layers of the multilayer thermal barrier 210 are the same as those described above. In some aspects, the thermal insulation layer extends beyond the dimensions of one or more of the resilient layers 214 and/or the thermal conductive layers 216 by a distance 229.

The layer configuration of the multilayer thermal barrier 210 includes the first and second resilient layers 214A, 214B in contact with opposing major surfaces of the thermal insulation layer 212. In some aspects, the first and second resilient layers 214A, 214B are in direct contact with the corresponding major surfaces of the thermal insulation layer 202. In other aspects, the first and second resilient layers 214A, 214B are in indirect contact with the thermal insulation layer 212, with an adhesive, thermal insulation layer encapsulation or coating, or some other material intervening therebetween.

A multilayer thermal barrier 220 is illustrated in FIG. 2C. The multilayer thermal barrier 220 includes a thermal insulation layer 222, a first resilient layer 224A, a second resilient layer 224B, and a thermal conductive layer 226. The compositions and materials for these layers have been described previously.

The thermal conductive layer 226 of the multilayer thermal barrier 220 is configured to encapsulate the thermal insulation layer 222. The thermal conductive layer 226 provides increased conduction capacity. The encapsulation layer 226 also protects the insulation layer 222 from particle bombards in a thermal runaway event. For aspects in which the thermal insulation layer 222 is fabricated from an aerogel material, the encapsulating thermal conductive layer 226 prevents aerogel dust from leaking out of the insulation layer 222.

In some aspects the thermal conductive layer 226 is formed from a single integral element, such as a conformable polymer layer that includes thermally conductive filler particles. In other aspects, the single integral element may be a graphitic layer. In other aspect, the thermal conductive layer 226 may be a metal layer, a metal alloy layer, a carbon layer, other heat conductive layers, or combinations thereof. In other aspects, the thermal conductive layer 226 is formed from one or more separate elements that are joined together (e.g., joined panels analogous to the first and second thermal conductive layers described above).

The multilayer thermal barrier 220 also include the first and second resilient layers 224A and 224B arranged on an exposed surface (or surfaces) of the thermal conductive layer 226 so that the thermal conductive layer 226 is between the thermal insulation layer 222 and the first and second resilient layers 224A and 224B.

The dimension 228 indicates a width of the first and second resilient layers 224A and 224B. As shown, a portion 223 of the thermal insulation layer 222 extends laterally beyond the dimension 228 by a dimension 229.

A multilayer thermal barrier 230 illustrated in FIG. 2D includes a thermal insulation layer 232, a first resilient layer 234A, a second resilient layer 234B (collectively, resilient layers 234), a first thermal conduction layer 236A, and a second thermal conductive layer 236B (collectively, thermal conduction layers 236).

In the multilayer thermal barrier 230, the first a resilient layer 234A is located between the thermal insulation layer 232 and the first thermal conductive layer 236A. The second resilient layer 234B is located between the thermal insulation layer 232 and the second thermal conductive layer 236B. The resilient layers 234 and the thermal conductive layers 236 having a width indicated by dimension 238. A portion 233 of the thermal insulation layer 232 extends laterally beyond the dimension 238 by a dimension 239.

The portion 233 of the thermal insulation layer 232 of the multilayer thermal barrier 230 has been further modified from a first thickness 242 to a second thickness 244 that is less than the first thickness 242. In one example, material from the thermal insulation layer 232 is removed to reduce the thickness of portion 233. Example techniques for reducing the thickness of the thermal insulation layer 232 from thickness 242 to thickness 244 include, but are not limited to, cutting with a blade (e.g., skiving), or initially forming the portion 233 different from a middle portion of the thermal insulation layer 232 (e.g., via a mold or die). In one example, the portion 233 is compressed or otherwise formed from the first thickness 242 down to the second thickness 244. Example methods of reduction include, but are not limited to, rolling, stamping, or other similar techniques.

FIG. 2E illustrates a cross sectional view of portion of a battery module that includes a thermal insulation layer 240 similar to a cross section along line A-A in FIG. 1A or line D-D in FIG. 2C. The thermal barrier 240 may include any of the aspects described above in the context of FIGS. 1 and 2A-2D.

A conductive layer 246 and a heat insulation layer as described above the thermal barrier 240 both have larger footprints than the footprint of a resilient layer 243. The footprint of the resilient layer 243 is defined by a length 248 times a width 247. The footprint of the resilient layer 243 may be the same as the footprint of the battery cells (not shown). The conductive layer 246 is in direct contact with a cooling plate 245, while the resilient layer 243 may optionally not in direct contact with the cooling plate 245. For example, the resilient layer 243 may be separated from the cooling plate 245 by a space 241, wherein the space 241 is filled with the conductive layer 246.

FIG. 2F illustrates a cross sectional view of a battery module 250 similar to module 100 along line B-B in FIG. 1A or line C-C in FIG. 2C. The battery module includes a thermal barrier 251. The battery module 250 may include any of the aspects described above in the context of FIGS. 1 and 2A-2D.

The battery module 250 includes groups of battery cells 110. Each group 110 comprises one or more battery cells 112. The battery module 250 further comprises a multilayer thermal barrier 251, which comprises a conductive layer 256 and resilient layers 254. The multilayer thermal barrier 251 may further comprises a heat insulation layer encapsulated in the conductive layer 256. The multilayer thermal barrier 251 has a thickness 252.

The conductive layer 256 of the multilayer thermal barrier 251 in the battery module 250 is shown in direct contact with the cooling plate 245, although the disclosure is not so limited. In one aspect, resilient layer 254 is not in direct contact with the cooling plate 245. For example, the resilient layer may be separated from the cooling plate 245 by a distance 253, wherein the distance 253 is filled with the conductive layer 256. As such the conductive layer has a T shaped cross section along its thickness. The T shaped cross section increases the contact surface of the conductive layer 256 and the cooling plate 245 to increase the heat dissipation rate.

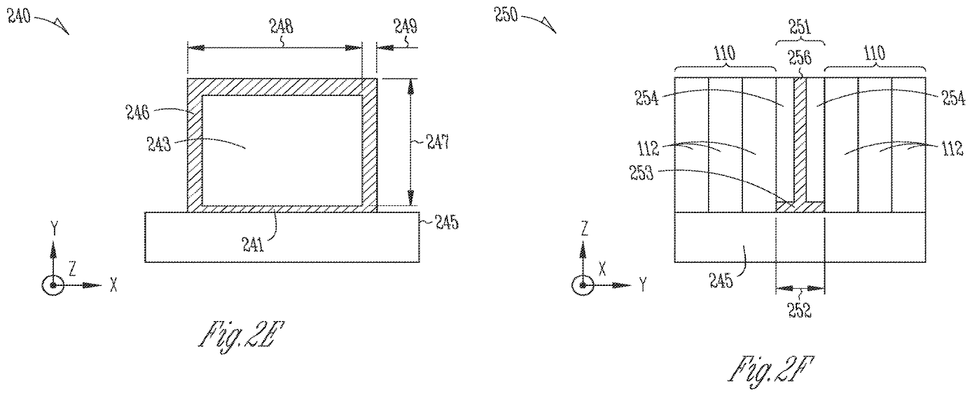

FIGS. 3A-3C illustrate compression of a multilayer thermal barrier 300 according to one example. In FIG. 3A, a multilayer thermal barrier 300 includes a thermal insulation layer 302. The multilayer thermal barrier 300 also includes a top and bottom resilient layer 304 and a top and bottom thermal conductor layer 306. In the example of FIG. 3A, the top and bottom resilient layers 304 are located between the thermal insulation layer 302 and the top and bottom thermal conductor layer 306. The thermal insulation layer 302 is shown having an initial thickness 312, while the whole multilayer thermal barrier 300 is shown having a thickness 310.

In FIG. 3B, the multilayer thermal barrier 300 is compressed as indicated by arrows 308. In FIG. 3B, the thickness 310 is reduced to a thickness that is closer to the thickness 312 as the resilient layers 304 are compressed. In FIG. 3C, the thickness 310 is further reduced to a thickness that is substantially equal to the thickness 312.

Although example multilayer thermal barrier and associated battery modules described above show multiple resilient layers and multiple thermal conductor layers with a single thermal insulation layer, the invention is not so limited. Other examples include multilayer thermal barriers with fewer layers or larger numbers of layers, depending on resiliency requirements, thermal barrier requirements, and thermal conduction requirements.

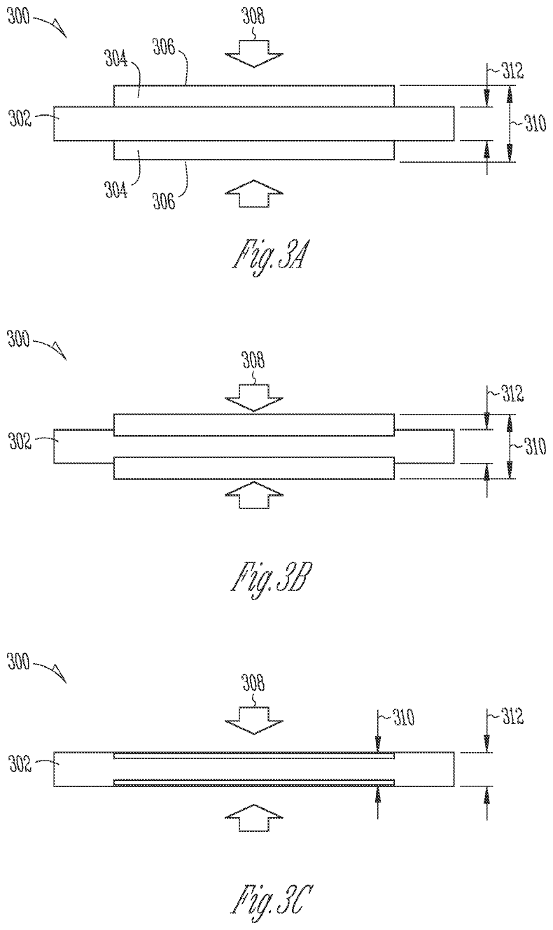

FIG. 4 shows a flow diagram of a method of manufacture according to one example. In operation 402, a number of lithium-ion pouch cells are stacked. In operation 404, a multilayer thermal barrier is stacked between cells in the stack of lithium-ion pouch cells. In one example, the multilayer thermal barrier includes an aerogel thermal insulation layer, a thermal conductive layer, and a resilient layer, stacked together with the aerogel thermal insulation layer and the thermal conductive layer, wherein the resilient layer is dimensioned to a footprint substantially the same size as a lithium-ion pouch cell, wherein the aerogel thermal insulation layer extends laterally beyond the footprint. In operation 406, the battery module is compressed, wherein the resilient layer of the multilayer thermal barrier compresses to a portion of its original thickness.

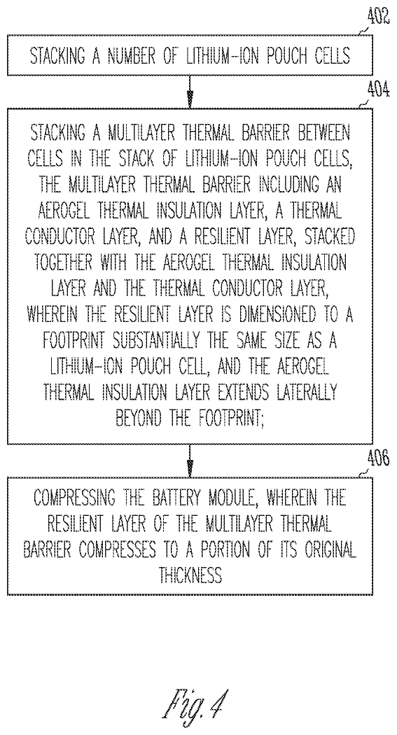

Battery modules that include multilayer thermal barriers as described above are used in a number of electronic devices. FIG. 5 illustrates an example electronic device 500 that includes a battery module 510. The battery module 510 is coupled to functional electronics 520 by circuitry 512. In the example shown, the battery module 510 and circuitry 512 are contained in a housing 502. A charge port 514 is shown coupled to the battery module 510 to facilitate recharging of the battery module 510 when needed.

In one example, the functional electronics 520 include devices such as semiconductor devices with transistors and storage circuits. Examples include, but are not limited to, telephones, computers, display screens, navigation systems, etc.

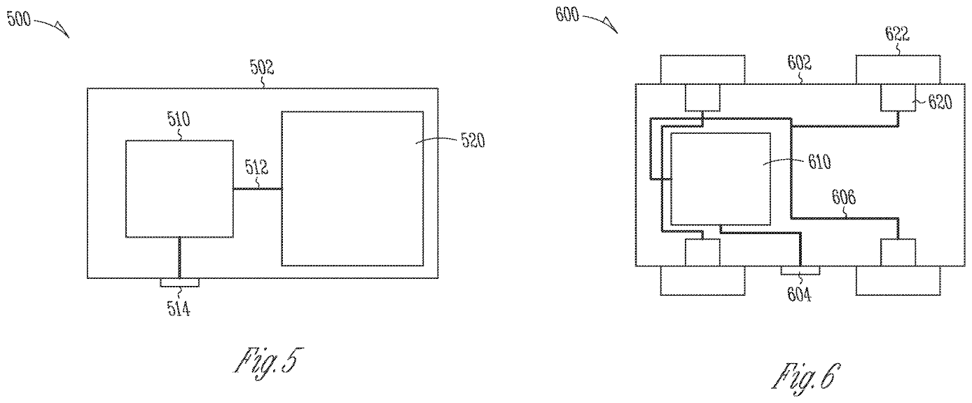

FIG. 6 illustrates another electronic system that utilizes battery modules that include multilayer thermal barriers as described above. An electric vehicle 600 is illustrated in FIG. 6. The electric vehicle 600 includes a chassis 602 and wheels 622. In the example shown, each wheel 622 is coupled to a drive motor 620. A battery module 610 is shown coupled to the drive motors 620 by circuitry 606. A charge port 604 is shown coupled to the battery module 610 to facilitate recharging of the battery module 610 when needed.

Examples of electric vehicle 600 include, but are not limited to, consumer vehicles such as cars, trucks, etc. Commercial vehicles such as tractors and semi-trucks are also within the scope of the invention. Although a four wheeled vehicle is shown, the invention is not so limited. For example, two wheeled vehicles such as motorcycles and scooters are also within the scope of the invention.

To better illustrate the method and apparatuses disclosed herein, a non-limiting list of aspects is provided here:

Aspect 1. A multilayer thermal barrier, comprising: a thermal insulation layer; a thermal conductive layer; and a resilient layer, stacked together with the thermal insulation layer and the thermal conductive layer, wherein the resilient layer is dimensioned to a footprint substantially a same size as a lithium-ion pouch cell; wherein the thermal insulation layer extends laterally beyond the footprint.

Aspect 2. The multilayer thermal barrier of aspect 1, wherein the thermal insulation layer includes an aerogel material.

Aspect 3. The multilayer thermal barrier of aspect 1, wherein the thermal conductive layer is dimensioned to a footprint substantially the same size as the resilient layer.

Aspect 4. The multilayer thermal barrier of aspect 1, wherein the thermal insulation layer is between the resilient layer and the thermal insulation layer.

Aspect 5. The multilayer thermal barrier of aspect 1, wherein: the thermal conductive layer comprises a first thermal conductive layer and a second thermal conductive layer; and the thermal insulation layer is between, and in direct contact with, the first thermal conductive layer and the second thermal conductive layer.

Aspect 6. The multilayer thermal barrier of aspect 5, wherein: the resilient layer comprises a first resilient layer and a second resilient layer; and the first resilient layer is in direct contact with the first thermal conductive layer and the second resilient layer is in direct contact with the second thermal conductive layer.

Aspect 7. The multilayer thermal barrier of aspect 6, wherein: the resilient layer comprises a first resilient layer and a second resilient layer; and the thermal insulation layer is between, and in direct contact with, the first resilient layer and the second resilient layer.

Aspect 8. The multilayer thermal barrier of aspect 7, wherein: the thermal conductive layer comprises a first thermal conductive layer and a second thermal conductive layer; and the first thermal conductive layer is in direct contact with the first resilient layer and the second thermal conductive layer is in direct contact with the second resilient layer.

Aspect 9. The multilayer thermal barrier of aspect 1, wherein the thermal insulation layer comprises: a first portion that overlaps with a corresponding portion of one or both of the thermal conductive layer and the resilient layer, the first portion having a first thickness, and a second portion that extends beyond the footprint, the second portion having a second thickness less than the first portion.

Aspect 10. A battery module, comprising: a stack of lithium-ion pouch cells; a multilayer thermal barrier located between cells in the stack of lithium-ion pouch cells, the multilayer thermal barrier including; a thermal insulation layer; a thermal conductive layer; and a resilient layer, stacked together with the thermal insulation layer and the thermal conductive layer, wherein the resilient layer is dimensioned to a footprint substantially a same size as a lithium-ion pouch cell; wherein the thermal insulation layer extends laterally beyond the footprint.

Aspect 11. The battery module of aspect 10, wherein the thermal insulation layer includes an aerogel material.

Aspect 12. The battery module of aspect 10, wherein one or more pouch cells in the stack of lithium-ion pouch cells includes opposing terminal electrodes extending from a pouch.

Aspect 13. The battery module of aspect 10, wherein the multilayer thermal barrier is located between two multiple pouch cell sub-units.

Aspect 14. The battery module of aspect 10, further comprising a heat sink in contact with a side of the stack of lithium-ion pouch cells, and thermally coupled to the thermal conductive layer.

Aspect 15. The battery module of aspect 10, wherein the thermal conductive layer encapsulates the thermal insulation layer.

Aspect 16. A method of making a battery module, comprising: stacking a number of battery cells to form a stack of battery cells; stacking a multilayer thermal barrier between cells in the stack of battery cells, the multilayer thermal barrier including; an aerogel thermal insulation layer; a thermal conductive layer; a resilient layer, stacked together with the aerogel thermal insulation layer and the thermal conductive layer, wherein the resilient layer is dimensioned to a footprint substantially a same size as a battery cell; wherein the aerogel thermal insulation layer extends laterally beyond the footprint; and compressing the battery module, wherein the resilient layer of the multilayer thermal barrier compresses to a portion of its original thickness.

Aspect 17. The method of aspect 16, further including reducing a thickness of a portion of the aerogel thermal insulation layer that extends laterally beyond the footprint.

Aspect 18. The method of aspect 17, wherein reducing a thickness includes compressing the portion.

Aspect 19. The method of aspect 17, wherein reducing a thickness includes removing material from the aerogel thermal insulation layer in the portion.

Aspect 20. The method of aspect 16, wherein compressing the battery module includes compressing the multilayer thermal barrier until a thickness of a central portion of the multilayer thermal barrier is substantially equal to a thickness of a portion of the aerogel thermal insulation layer that extends laterally beyond the footprint.

The above description is intended to be illustrative, and not restrictive. For example, the above-described aspects (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate aspect, and it is contemplated that such aspects can be combined with each other in various combinations or permutations. The scope of the invention should be determined with reference to the appended claims, along with the full scope of equivalents to which such claims are entitled.

Although an overview of the inventive subject matter has been described with reference to specific example aspects, various modifications and changes may be made to these aspects without departing from the broader scope of aspects of the present disclosure. Such aspects of the inventive subject matter may be referred to herein, individually or collectively, by the term “invention” merely for convenience and without intending to voluntarily limit the scope of this application to any single disclosure or inventive concept if more than one is, in fact, disclosed.

The aspects illustrated herein are described in sufficient detail to enable those skilled in the art to practice the teachings disclosed. Other aspects may be used and derived therefrom, such that structural and logical substitutions and changes may be made without departing from the scope of this disclosure. The Detailed Description, therefore, is not to be taken in a limiting sense, and the scope of various aspects is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various aspects of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of aspects of the present disclosure as represented by the appended claims. The specification and drawings are, accordingly, to be regarded in an illustrative rather than a restrictive sense.

The foregoing description, for the purpose of explanation, has been described with reference to specific example aspects. However, the illustrative discussions above are not intended to be exhaustive or to limit the possible example aspects to the precise forms disclosed. Many modifications and variations are possible in view of the above teachings. The example aspects were chosen and described in order to best explain the principals involved and their practical applications, to thereby enable others skilled in the art to best utilize the various example aspects with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example aspects. The first contact and the second contact are both contacts, but they are not the same contact.

The terminology used in the description of the example aspects herein is for the purpose of describing particular example aspects only and is not intended to be limiting. As used in the description of the example aspects and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A multilayer thermal barrier, comprising:
a thermal insulation layer;
a thermal conductive layer, and
a resilient layer, stacked together with the thermal insulation layer and the thermal conductive layer, wherein the resilient layer is dimensioned to a footprint substantially a same size as a lithium-ion pouch cell;
wherein the thermal insulation layer extends laterally beyond the footprint.

2. The multilayer thermal barrier of claim 1, wherein the thermal insulation layer includes an aerogel material.

3. The multilayer thermal barrier of claim 1, wherein the thermal conductive layer is dimensioned to a footprint substantially the same size as the resilient layer.

4. The multilayer thermal barrier of claim 1, wherein the thermal insulation layer is between the resilient layer and the thermal insulation layer.

5. The multilayer thermal barrier of claim 1, wherein:
the thermal conductive layer comprises a first thermal conductive layer and a second thermal conductive layer; and
the thermal insulation layer is between, and in direct contact with, the first thermal conductive layer and the second thermal conductive layer.

6. The multilayer thermal barrier of claim 5, wherein:
the resilient layer comprises a first resilient layer and a second resilient layer; and
the first resilient layer is in direct contact with the first thermal conductive layer and the second resilient layer is in direct contact with the second thermal conductive layer.

7. The multilayer thermal barrier of claim 6, wherein:
the resilient layer comprises a first resilient layer and a second resilient layer, and
the thermal insulation layer is between, and in direct contact with, the first resilient layer and the second resilient layer.

8. The multilayer thermal barrier of claim 7, wherein:
the thermal conductive layer comprises a first thermal conductive layer and a second thermal conductive layer; and
the first thermal conductive layer is in direct contact with the first resilient layer and the second thermal conductive layer is in direct contact with the second resilient layer.

9. The multilayer thermal barrier of claim 1, wherein the thermal insulation layer comprises:
a first portion that overlaps with a corresponding portion of one or both of the thermal conductive layer and the resilient layer, the first portion having a first thickness; and
a second portion that extends beyond the footprint, the second portion having a second thickness less than the first portion.

10. A battery module, comprising:
a stack of lithium-ion pouch cells;
a multilayer thermal barrier located between cells in the stack of lithium-ion pouch cells, the multilayer thermal barrier including;
a thermal insulation layer;
a thermal conductive layer; and
a resilient layer, stacked together with the thermal insulation layer and the thermal conductive layer, wherein the resilient layer is dimensioned to a footprint substantially a same size as a lithium-ion pouch cell;
wherein the thermal insulation layer extends laterally beyond the footprint.

11. The battery module of claim 10, wherein the thermal insulation layer includes an aerogel material.

12. The battery module of claim 10, wherein one or more pouch cells in the stack of lithium-ion pouch cells includes opposing terminal electrodes extending from a pouch.

13. The battery module of claim 10, wherein the multilayer thermal barrier is located between two multiple pouch cell sub-units.

14. The battery module of claim 10, further comprising a heat sink in contact with a side of the stack of lithium-ion pouch cells, and thermally coupled to the thermal conductive layer.

15. The battery module of claim 10, wherein the thermal conductive layer encapsulates the thermal insulation layer.

16. A method of making a battery module, comprising:
stacking a number of battery cells to form a stack of battery cells;
stacking a multilayer thermal barrier between cells in the stack of battery cells, the multilayer thermal barrier including;
an aerogel thermal insulation layer;
a thermal conductive layer;
a resilient layer, stacked together with the aerogel thermal insulation layer and the thermal conductive layer, wherein the resilient layer is dimensioned to a footprint substantially a same size as a battery cell;
wherein the aerogel thermal insulation layer extends laterally beyond the footprint; and
compressing the battery module, wherein the resilient layer of the multilayer thermal barrier compresses to a portion of its original thickness.

17. The method of claim 16, further including reducing a thickness of a portion of the aerogel thermal insulation layer that extends laterally beyond the footprint.

18. The method of claim 17, wherein reducing a thickness includes compressing the portion.

19. The method of claim 17, wherein reducing a thickness includes removing material from the aerogel thermal insulation layer in the portion.

20. The method of claim 16, wherein compressing the battery module includes compressing the multilayer thermal barrier until a thickness of a central portion of the multilayer thermal barrier is substantially equal to a thickness of a portion of the aerogel thermal insulation layer that extends laterally beyond the footprint.
